(19) United States
(12) Patent Application Publication
(10) Pub. No.: US 2007/0205725 A1
(43) Pub. Date: Sep. 6, 2007

(54) Electronic Power Control For Lamps

(75) Inventor: David Bastians, Gilles Plains (AU)

Correspondence Address: OSHA LIANG L.L.P., 1221 MCKINNEY STREET, SUITE 2800, HOUSTON, TX, 77010, US

(73) Assignee: Vicious Power Pty Ltd, Gilles Plains (AU)

(21) Appl. No.: 10/576,043

(22) PCT Filed: Oct. 15, 2004
(86) PCT No.: PCT/AU04/01415

§ 371 Date: Jan. 11, 2007

(30) Foreign Application Priority Data
Oct. 17, 2003 (AU) 2003905705

(51) Int. Cl. H05B 41/16

(52) U.S. Cl. 315/219

(57) ABSTRACT

A power controller for use with lighting systems including a direct current voltage source, a coil of known inductance, a switch means adapted to control application of the source voltage to the coil, means adapted to select a required duty cycle for the switch such that the input power level is substantially constant, and means adapted to control operation of the switch such that this selected duty cycle is effected. A switch mode DC-DC converter is disclosed, wherein regulation occurs by manipulation of input power, without current monitoring.

### TECHNICAL FIELD

This invention relates to a method of providing electrical power for portable lighting systems and is also directed to a controller and an installation where a battery power source is used with portable lighting systems that require controlled DC power that is continuous such as metal halide arc lamps and light emitting diodes.

### BACKGROUND ART

A disadvantage with prior art devices is that they allow light output, which is highly sensitive to the available voltage, to vary as a battery supply passes through charge states. This can be highly disadvantageous in situations where the extent of light available is very important. U.S. Pat. No. 5,291,900 discloses a more sophisticated low watt metal halide lamp apparatus. It utilizes a DC voltage regulator (boost topology) to turn the range of 6-15 VDC into a steady 15 VDC. This controlled voltage is then used to deliver electrical current to an arc lamp via a flyback transformer with rectified output

The use of the a regulator to feed a constant DC input to the power transformer allows system stability with the use of more than one battery combination. However, the need for the DC regulator detracts from the electrical efficiency of the ballast, increases physical size of the circuitry, and adds parts to the bill of materials increasing cost and decreasing reliability.

LEDs typically operate in response to a specified level of current flow but have a characteristic voltage drop across the diode associated with their normal running power. Although they require a controlled amount of current flow for proper function, they do not normally offer any inherent current limiting capacity.

The cheapest and simplest method of current control in the prior art is to use a “fixed” voltage power source, in series with a LED array and a current limiting resistor.

A disadvantage of this apparatus is that the current limiting resistor dissipates a significant percentage of the total power, leading to poor over-all efficiency. Also, as battery voltage drops, current in the circuit will also drop, leading to a significant loss of light output from the LED.

A better approach is to use a current regulated driver, employing a resistor in series with the LED array acting as a current sense resistor to provide a feedback signal to a pulse width modulation controller to ensure constant current flow through the LED array.

The current regulated driver offers constant brightness of LEDs even as input voltage falls over time (e.g. a discharging battery). A disadvantage is the power dissipated in the current sensing resistor. The current sense resistor can be of low ohmic value to reduce this loss, however, low ohm resistors of precise value are more expensive than more commonly available components.

An object of this invention is to provide a power controller that can operate lighting systems that require controlled DC power that is continuous, such as arc lamps and LED's, using a regulation technique which is efficient both from a point of view of power usage, therefore enabling longer use from a battery charge; and from a manufacturing cost point of view.

### DISCLOSURE OF THE INVENTION

In one form of the invention, the invention may be said to reside in a power controller for use with lighting systems including a direct current voltage source, a coil of known inductance, a switch means adapted to control application of the source voltage to the coil, means adapted to select a required duty cycle for the switch such that the input power level is substantially constant, and means adapted to control operation of the switch such that this selected duty cycle is effected.

In a further form the invention can be said to reside in an assembly with a power controller as described coupled to an electric-to-light output transducer.

In preference the transducer is an arc lamp.

In the alternative the transducer is one or more light emitting diodes.

In one form of the invention, the invention may be said to reside in a method of effecting a supply of electrical power to an electrical-to-light output transducer where the input from a direct current supply is directed into a means which will effect transition into an output wherein said means further includes means to effect frequent switching wherein the mark-space ratio of the switching is able to be modified such that the input power is held effectively constant. In an alternative form the invention can be said to reside in an apparatus adapted to perform this method.

In preference in the alternative the invention includes a power controller for use with high performance portable lighting systems including a DC voltage source, a transformer including a primary and a secondary coil, a switch means adapted to control application of the source voltage to the primary coil of said transformer, means adapted to control the operation of the switch, and means adapted to select a required duty cycle for the switch such that the level of power delivered to the primary coil is substantially constant, said power controller being adapted to provide a substantially constant power throughput

In preference, the means adapted to select the duty cycle of the switch includes means to sense the magnitude of a voltage being provided by the voltage source. This allows the battery voltage, which varies according to its discharge cycle, to be monitored and not to affect the output as such being supplied to the electric-to-light transducer.

In preference, the means to determine the duty cycle of the switch calculates this duty cycle according to the fixed mathematical relationship between said duty cycle and source voltage, the inductance of the coil and a desired power throughput of the device.

In preference, the means adapted to select the duty cycle of the switch includes a microprocessor.

In preference, the means to calculate the duty cycle of the switch include stored instructions adapted to be followed by the microprocessor.

In preference, the voltage source is unregulated. This voltage source may be a battery.

In preference, there is at least one diode and at least one capacitor, arranged to co-operate with the switch and the coil to form a switchmode DC-DC converter.

### BRIEF DESCRIPTION OF THE DRAWINGS

For a better understanding of this invention, it will now be described with respect to the prior art and to a preferred embodiment which shall be described herein with the assistance of drawings wherein;

FIG. 1 is a circuit diagram of a ballast of the prior art adapted for use with an arc lamp;

FIG. 2 is a circuit diagram of a power controller of the prior art including an independent regulator for the DC voltage;

FIG. 3 is a circuit diagram of an LED drive circuit of the prior art using a current limiting resistor;

FIG. 4 is a LED driver of the prior art employing current regulation;

FIG. 5 is a circuit diagram of a preferred embodiment of the present invention, incorporating a flyback converter;

FIG. 6 is a more detailed circuit diagram of a preferred embodiment of the present invention showing it adapted for use with an arc lamp circuit;

FIG. 7 is a circuit diagram of a preferred embodiment of the present invention, incorporating a buck-boost converter;

FIG. 8 is a circuit diagram of a preferred embodiment of the present invention, incorporating a buck converter.

FIG. 9 is a listing of the assembly language code stored in the microprocessor to effect the calculation of the switch period.

### BEST MODE FOR CARRYING OUT THE INVENTION

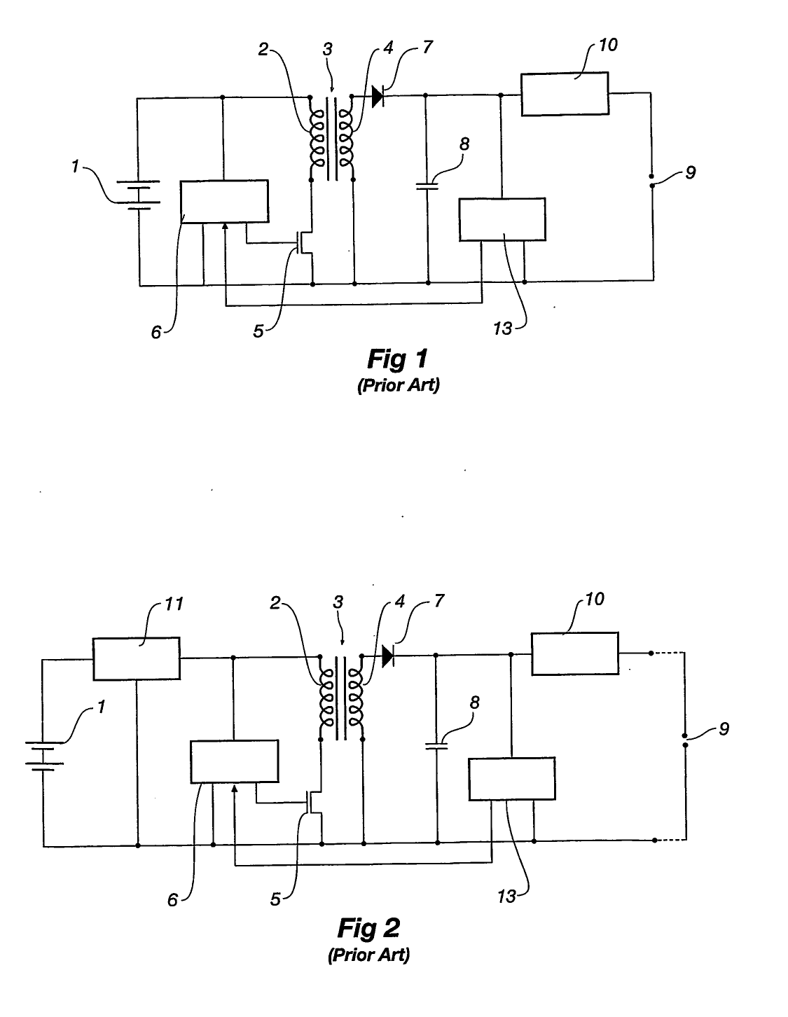

FIG. 1 shows a circuit diagram of a simple commercially available arc lamp apparatus. Arc lamps typically require a voltage pulse of around 6,000 volts to strike the arc and then typically 50-100 volts to continue running.

In portable applications, Power supply circuitry is required in order to produce these voltages from a battery. FIG. 1 shows a circuit for such a power supply in the form of a simple flyback DC-DC converter. This consists of a battery 1 providing voltage to the primary coil 2 of a transformer 3 and a switch 5 under the control of an oscillator 6. The high voltage output is drawn from the secondary coil 4 of the transformer via a rectifier circuit consisting of diode 7 and capacitor 8. The 6,000 volt pulse required to strike the arc of the lamp 9 is provided by the trigger circuit 10.

The main disadvantage of the simple circuit of FIG. 1 is that it employs no regulation and therefore power delivery varies with input voltage. The unregulated power supply can only be used with a limited range of battery combinations with narrow voltage specifications.

FIG. 2 shows a prior art power supply for an arc lamp similar to that of FIG. 1 but with the addition of a DC voltage regulator 11. This fixes the input voltage applied to the primary coil 2 of the transformer 3 at a value of 15 volts. This allows for stable operation over a wider range of input voltages from 6-15 volts but it does this at the expense of additional circuitry and a reduction in the efficiency of operation of the circuit

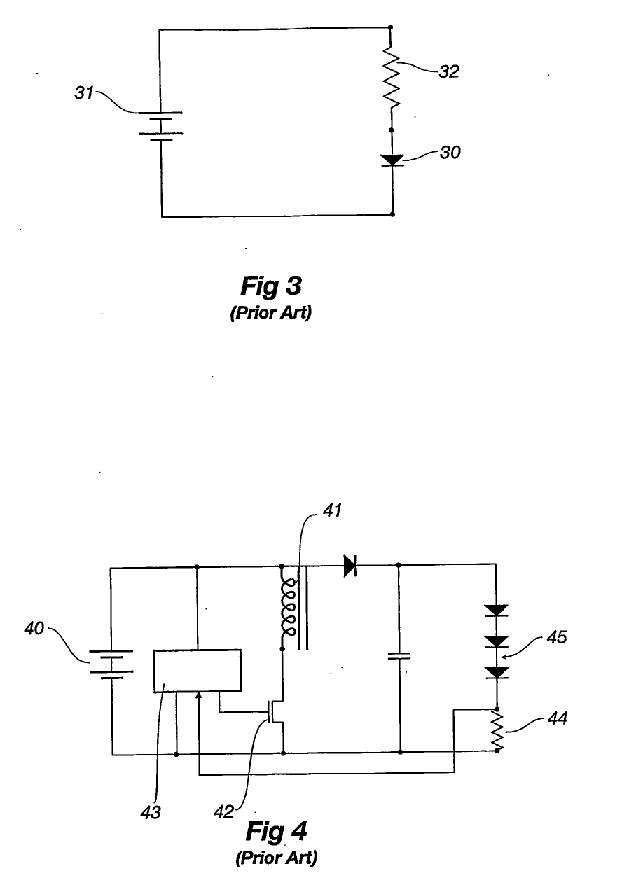

FIG. 3 shows a prior art implementation of a LED drive incorporating a current limiting resistance. LED 30 has a characteristic voltage drop of 3 volts and a characteristic operating current of 350 milliamps. When driven from a 6 volt DC source 31 it is necessary to provide a resistor to limit the current flowing through the diode to a value approximating its rate at current capacity. In this case, the voltage drop across the resistor 32 will be 3 volts and to achieve a current of 360 milliamps a value for the resistor of 8.2 ohms is chosen.

This circuit provides appropriate current drive to the LED but at the expense of very poor efficiency since a significant percentage of the total power is dissipated in the current limiting resister. Also the current is unregulated meaning that it will vary with the varying voltage of the battery 31 during its discharge cycle and the output of the LED will vary accordingly.

FIG. 4 shows a current regulated LED driver circuit. A battery 40 supplies power to a power supply consisting of inductor 41, MOSFET switch 42 and pulse wave modulation (PWM) controller 43. The period of the switch is set by the PWM controller in order to maintain the voltage across the current sensing resistor 44 at a substantially constant level. Hence the current flowing through the LED chain 45 is maintained substantially constant

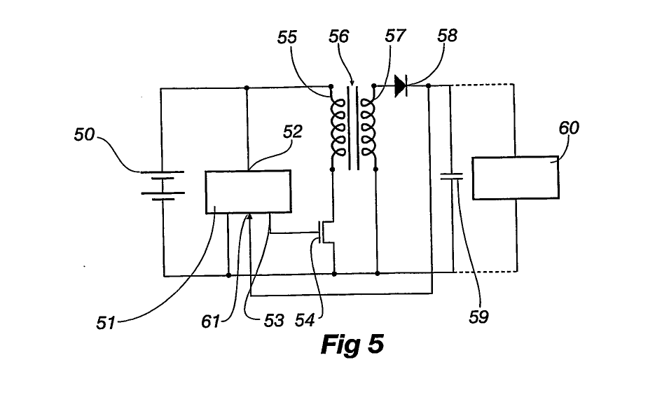

FIG. 5 is a circuit diagram of a lamp power supply according to an embodiment of the present invention. The power source to the power controller is a battery 50 which may be one of a variety of voltage levels and need not provide a fixed voltage input. There is a microcontroller chip 51 which has a voltage sensing input 52 and an output 53 which controls a switch in the form of a MOSFET transistor 54. This switch controls the supply of power to a primary coil 55 of a transformer 56. This transformer has a secondary coil 57 to which is connected a rectifier circuit consisting of diode 58 and capacitor 59. There is a voltage sensing input 61 that can be used for monitoring of load status and for calculating required duty cycle in topologies where power control is more complex. The load on the circuit 60 may be an arc lamp including an arc lamp trigger circuit or an LED or an array of LEDs.

The controller of this embodiment achieves power regulation based on the principle that energy stored in the primary inductance of the transformer is V²t²/L where V represents input voltage, t is the period of the primary switch and L is the inductance of the primary coil of the transformer. Accordingly, the output power is proportional to V²d²/L where d is the duty cycle of the switch. The inductance has a constant value, hence this fixed mathematical relationship allows the appropriate duty cycle to be determined to ensure a required constant power level.

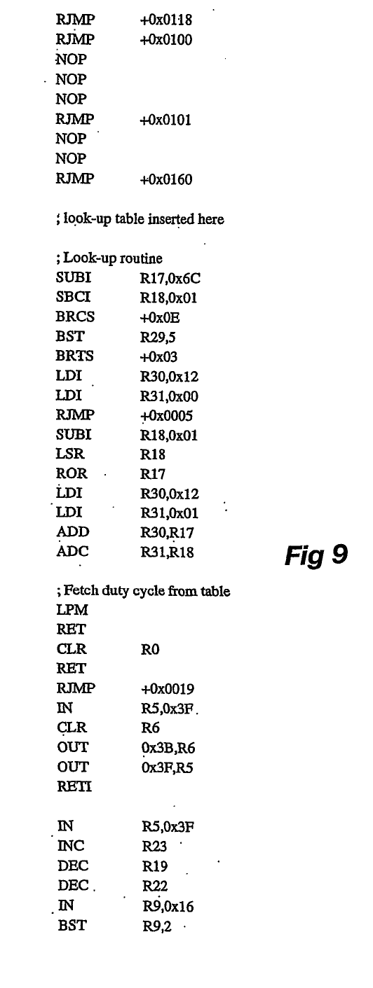

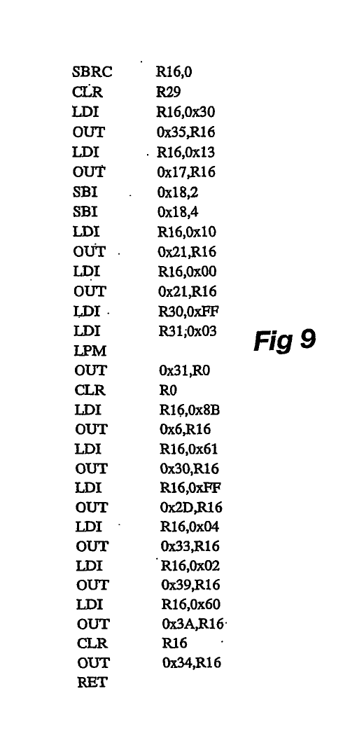

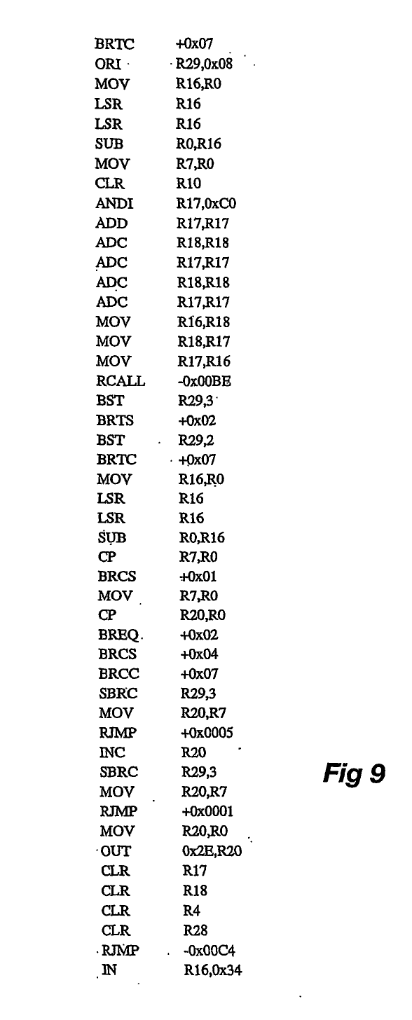

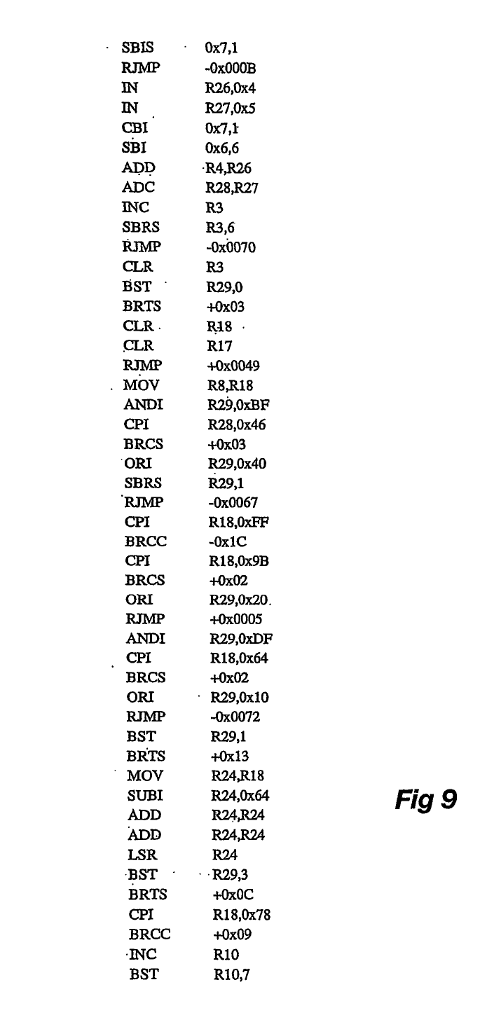

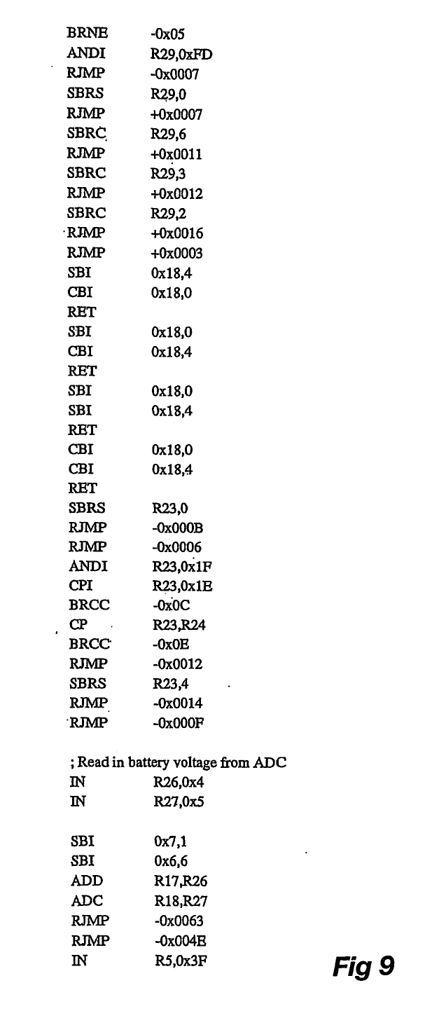

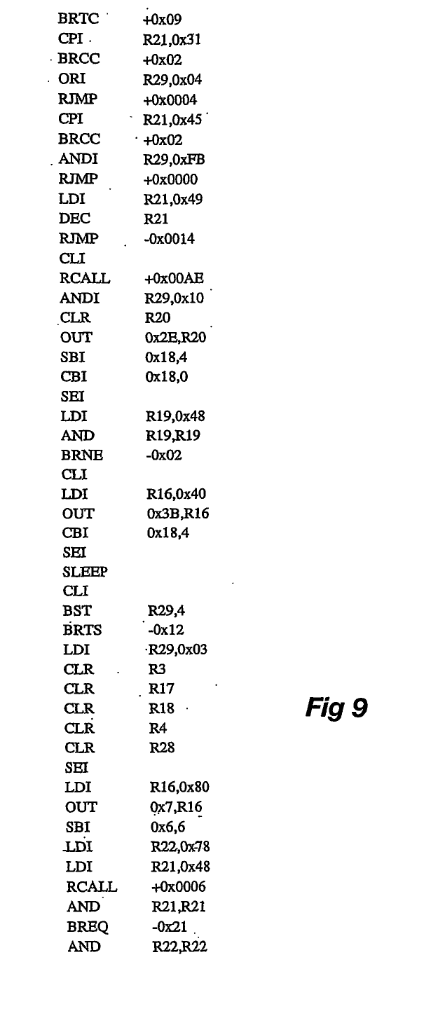

The microcontroller 51 samples the input voltage. The value of the inductance of the primary coil of the power transformer is supplied to the microcontroller as a constant value during set up. The microcontroller includes stored instructions which are shown as FIG. 9 allowing it to calculate the duty cycle of the switch according to the above formula such that there is always a constant power being delivered from the battery to the primary coil of the transformer and accordingly into the load. This system avoids the need for separate DC voltage regulator or for a current limiting or current sensing resister. Accordingly, the embodiment of the invention is both more efficient and cheaper to manufacture than devices of the prior art.

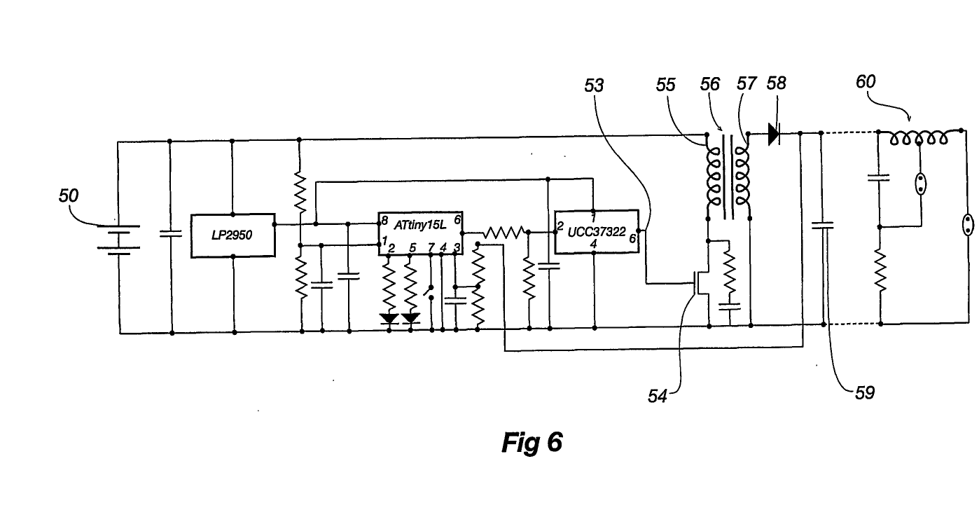

The DC-DC converter illustrated in FIG. 5 and FIG. 6 is a flyback converter. The technique of power control is not limited to the flyback transformer topology as illustrated in FIG. 6. The method can be applied to any inductor-based switchmode converter where the inductance of the main power inductor is fixed.

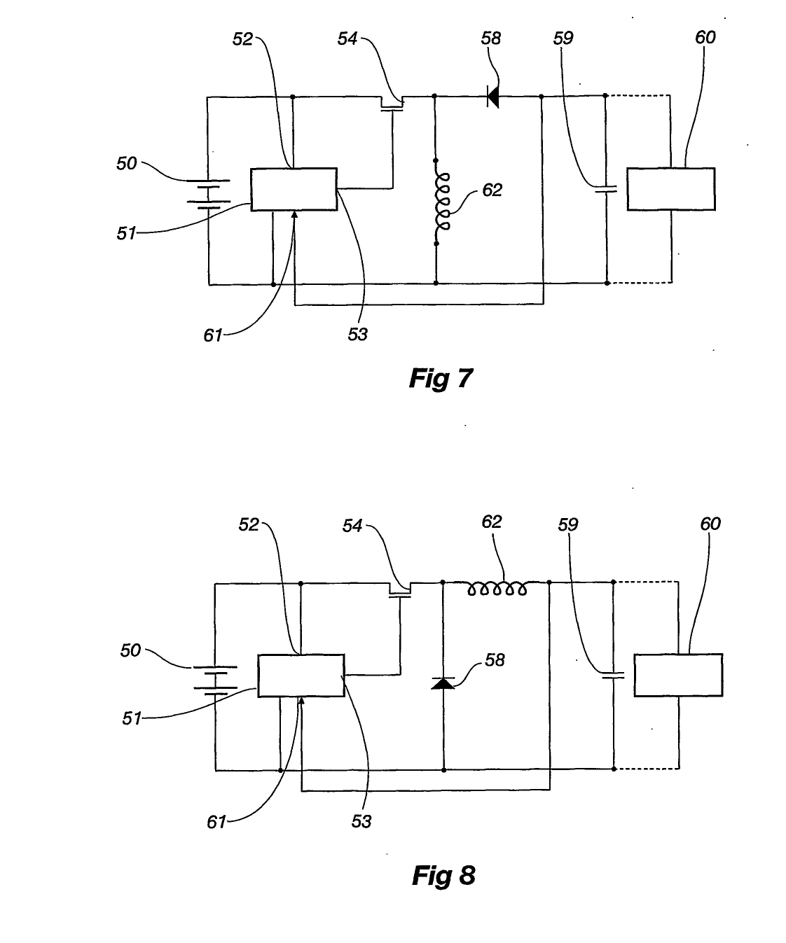

FIG. 7 illustrates shows a buck-boost DC-DC converter. The mathematical relationship between input voltage, duty cycle, and power throughput is the same as for the flyback transformer of FIG. 5. The components and theory of operation are as described for FIG. 5 but an inductor 62 is used instead of a transformer.

FIG. 8 shows a buck DC-DC converter. The components and theory of operation are as described for FIG. 5 but an inductor 62 is used instead of a transformer. The calculations that the microcontroller would need to make are more complex in this case, as the output voltage is a factor in the power fed into the main power inductor. This is made available to the microprocessor by input 61. The output voltage can be measured and the output power hence calculated.

The relevant equation is that power is proportional to (Vᵢₙ-Vₒᵤₜ)²d²/(L·(1-Vᵢₙ/Vₒᵤₜ)). Likewise, a boost topology could be used. The relevant equation would then be power is proportional to Vᵢₙ²d²/(L·(1-Vᵢₙ/Vₒᵤₜ)).

Monitoring the voltage out may be used for monitoring the status of the lighting element in this design. In the example of arc lamps, it is preferable to shut down the power if the lamp ever becomes disconnected and hence avoid arcing into the ambient environment. It is also possible to use this output voltage measurement to make adjustments to the power such that the system approximates a constant output current. However, in the embodiments of this invention, the output current is not required to be measured.

Throughout this specification the purpose has been to illustrate the invention and not to limit this.

1. A power controller for use with lighting systems including:
a direct current voltage source,
a coil of known inductance,
a switch means adapted to control application of the source voltage to the coil,
means adapted to select a required duty cycle for the switch such that the input power level is substantially constant, and
means adapted to control operation of the switch such that this selected duty cycle is effected.

2. A power controller as in claim 1, further including means to rectify an output of the coil.

3. A power controller as in claim 1 further including at least one diode and at least one capacitor, arranged to co-operate with the switch and the coil to form a switchmode DC-DC converter.

4. A power supply as in claim 3 wherein the switchmode power supply is a but-boost converter.

5. A power supply as in claim 3 wherein the switchmode power supply is a buck converter.

6. A power supply as in claim 3 wherein the switchmode power supply is a boost converter.

7. A power controller as in claim 1 wherein the coil is a primary coil of a transformer, further including a secondary coil, the switch means being adapted to control application of the source voltage to the primary coil of said transformer.

8. A power controller as in claim 7 further including at least one diode and at least one capacitor, arranged to co-operate with the switch and the transformer to form a switchmode DC-DC converter.

9. A power supply as in claim 8 wherein the switchmode power supply is a flyback converter.

10. A power controller as in claim 1, wherein the power controller is coupled to an electric-to-light output transducer.

11. A power controller as in claim 10 wherein the transducer is an arc lamp.

12. A power controller as in claim 10 wherein the transducer is one or more light emitting diodes.

13. A power controller as in claim 1, wherein the means adapted to select the required duty cycle includes means to sense the magnitude of a voltage being provided by the voltage source.

14. A power controller as in claim 1, wherein the means adapted to select the duty cycle of the switch calculates this duty cycle according to a fixed mathematical relationship between said duty cycle and the voltage provided by the voltage source, the inductance of the coil and a desired power throughput of the device.

15. A power controller as in claim 1, wherein the means adapted to determine the duty cycle of the switch includes a microprocessor.

16. A power controller as in claim 15 wherein the means to calculate the duty cycle of the switch includes stored instructions which the microprocessor is adapted to follow.

17. A power controller as in claim 15, wherein the means to sense the magnitude of a voltage being provided by the voltage source is an input to the microprocessor.

18. A power controller as in claim 1, wherein the voltage source is a battery.

19. A method of effecting a supply of electrical power to an electrical-to-light output transducer, comprising:
directing an input from a direct current supply to a means for effecting transition into an outputs wherein said means includes means to effect frequent switching,
wherein a mark-space ratio of the switching is modifiable such that the input power is held substantially constant.

20. (canceled)

21. (canceled)

22. A power controller as in claim 16, wherein the means to sense the magnitude of a voltage being provided by the voltage source is an input to the microprocessor.
